(19) United States
(12) Patent Application Publication
(10) Pub. No.: US 2021/0092122 A1
(43) Pub. Date: Mar. 25, 2021

(54) CENTRALIZED CAPABILITY SYSTEM FOR PROGRAMMABLE SWITCHES

(71) Applicant: VMware, Inc., Palo Alto, CA (US)

(72) Inventors: Gerd ZELLWEGER, Mountain View, CA (US); Stanko NOVAKOVIC, Mountain View, CA (US)

(21) Appl. No.: 16/579,310

(22) Filed: Sep. 23, 2019

(51) Int. Cl. H04L 29/06

(52) U.S. Cl. CPC H04L 63/101; H04L 63/062

(57) ABSTRACT

Embodiments described herein involve resource protection in a network. Embodiments include receiving, by a switch, a grant message from a first computing entity including a key and an indication of a first capability granted to a second computing entity to perform one or more operations with respect to a resource. Embodiments include generating, by the switch, an entry in a capability table based on the grant message. Embodiments include receiving, by the switch, a request from the second computing entity to perform an operation of the one or more operations with respect to the resource, wherein the request comprises the key. Embodiments include confirming, by the switch, that the second computing entity is permitted to perform the operation based on the key and the entry in the capability table. Embodiments include transmitting, by the switch, the request to the first computing entity in response to the confirming.

### BACKGROUND

Servers and other computing devices may share their resources with each other, such as within a rack-scale system or a data center. For example, a first server may grant a second server access to a region of the first server's memory to perform particular operations, such as reading and/or writing with respect to the region of memory. Allowing resource sharing between computing devices raises issues related to resource protection. For instance, a second computing device may attempt to access a resource of a first computing device without authorization, or may attempt to exceed the scope of access granted to it by the first computing device.

As such, there is a need in the art for techniques that allow resources to be shared in computing environments such as rack-scale systems and data centers while providing effective control over access to the resources.

### SUMMARY

Herein described are one or more embodiments of a method for resource control. The method generally includes: receiving, by a switch in the network, a grant message from a first computing entity in the network, wherein the grant message comprises: a key; and an indication of a first capability granted to a second computing entity in the network to perform one or more operations with respect to a resource related to the first computing entity; generating, by the switch, an entry in a capability table based on the grant message; receiving, by the switch, a request from the second computing entity to perform an operation of the one or more operations with respect to the resource, wherein the request comprises the key; confirming, by the switch, that the second computing entity is permitted to perform the operation based on the key and the entry in the capability table; and transmitting, by the switch, the request to the first computing entity in response to the confirming.

Also described herein are embodiments of a computer system, wherein software for the computer system is programmed to execute the method described above for resource control.

Also described herein are embodiments of a non-transitory computer readable medium comprising instructions to be executed in a computer system, wherein the instructions when executed in the computer system perform the method described above for resource control.

### BRIEF DESCRIPTION OF THE DRAWINGS

FIG. 1 illustrates a computing environment within which embodiments of the present disclosure may be implemented.

FIG. 2 illustrates an example of resource control according to embodiments of the present disclosure.

FIG. 3 illustrates an example of a capability table according to embodiments of the present disclosure.

FIG. 4 illustrates example operations for resource control according to embodiments of the present disclosure.

FIG. 5 illustrates additional example operations for resource control according to embodiments of the present disclosure.

### DETAILED DESCRIPTION

Allowing resources to be shared between computing entities such as servers in a computing environment such as a rack-scale system or a data center requires an effective resource control mechanism. One technique for enforcing fine-grained and flexible access control involves the use of capabilities. A capability can be thought of as a “key” or “license”. It is a unique token that grants authority with respect to a resource. Possession of a capability for a resource gives the holder the right to perform certain operations on the resource it represents, such as read or write access to a memory region or another entity in a system (e.g., the right to invoke a particular application). Techniques described herein involve a variant of capabilities that may be referred to as sparse capabilities. Sparse capabilities involve implementing capabilities as bit patterns representing a small subset of the full capability space. For example, certain embodiments involve a variant called password capabilities in which a key comprising a random bit stream is stored in association with an identifier of a resource and information indicating the rights that are granted. A resource control authority has a list of these password capabilities, such as in a table, and uses them to determine whether to grant requests to perform operations with respect to resources based on information included in the requests.

Modern switches, such as Ethernet switches, support many advanced features that can be controlled through programmable interfaces. These features include custom parsing of packet content and the use of programmable match-action rules (e.g., rules that match actions with conditions) with the ability to modify/rewrite, route, drop or forward packets. With these programmatic control mechanisms, switches can be used as effective building blocks for implementing fine-grained permission control systems by controlling admission of network packets at line rate (e.g., the rate at which packets are received).

Accordingly, techniques described herein involve using a programmable switch to augment the switching logic in a computing environment with support for a special packet format that allows permission checks based on capabilities provided between connected computing entities such as servers. Certain embodiments provide the ability to freely transfer capabilities from one computing entity to another, to create new derived capabilities from existing capabilities (e.g., with equal or reduced rights), and to revoke existing capabilities.

In certain embodiments, a capability is represented by an identifier of a resource (e.g., an address of the beginning of a memory region and a length of the memory region), an indication of rights (e.g., read, write, invoke, and/or the like), and a key. The key is generally a unique bit pattern associated with a given capability that is kept secret between a providing computing entity, a receiving computing entity, and the switch, and is used by the switch to confirm that the receiving computing entity has a valid capability. In some embodiments, keys are randomly generated.

Certain techniques involving programming the switch to parse packets with a header that includes a capability along with an indication of a command. The command can be, for example, grant, mint, revoke, invoke, read, write, or the like. A grant command is used to grant a capability to a computing entity. A mint command is used by a computing entity that has already been granted a capability to provide a subset of the capability to another computing entity. A revoke command is used to revoke a previously-provided capability. An invoke command is used to invoke a given capability, such as executing a given application or performing a remote procedure call (RPC). Read and write commands are used specifically to invoke read and write operations with respect to a memory region or one or more disk blocks. In some embodiments, the header also includes a destination address of a computing entity to which a packet is directed and/or a source address of the computing entity from which the packet is sent.

In an embodiment, a first computing entity issues a grant message in order to grant a capability to a second computing entity to read and write with respect to a particular memory region of the first computing entity. The switch receives the grant message, parses the header, and generates an entry in a capability table in order to “register” the capability for the second computing entity. The switch then forwards the grant message to the second computing entity. Subsequently, the second computing entity can issue a read, write, invoke, mine, and/or revoke message, which the switch receives and parses. The switch checks the capability table to ensure that there is an entry indicating that the second computing device has the rights to perform the requested operation, and ensures that a key included in the message matches the key in the entry. Upon successful verification, the switch forwards the message to the first computing entity so that the requested operation can be performed with respect to the particular memory region. The first computing device can trust that the message is approved without performing any independent verification, as the switch act as a central resource control authority and only forwards messages that are approved. The switch will drop messages that attempt to invoke capabilities that have not been registered in the capability table.

In one embodiment, after the second computing entity has been granted the capability, the second computing entity issues a mint message in order to grant a third computing entity a subset of the rights in the capability, such as the right to perform read operations on the particular memory region. The mint message includes a new key as well as the key associated with the capability. The switch parses the message and verifies that the second computing entity has the rights that it is attempting to provide to the third computing entity by checking the capability table and, upon successful verification, generates a new entry in the capability table indicating the third computing entity has the subset of the rights in the capability. The new entry includes the new key. The switch then forwards the mint message to the third computing entity. In some embodiments, metadata associated with the capability table includes a tree structure indicating that the key is a subset of the new key. As such, if the first computing entity revokes the capability from the second computing entity by sending a revoke message, the minted capability provided to the third computing entity is also revoked, as it is derived from the capability.

The switch generally performs resource control on an ongoing basis using the capability table, ensuring that capabilities are verified and enforced in a centralized manner. As such, techniques described herein allow resources to be shared between computing entities in a computing environment while ensuring fine-grained control over access to the resources. In some embodiments, the switch ensures that all keys are unique, rejecting a grant or mint message if the key included with the message is not unique compared to all other keys registered in the capability table. In other embodiments, the switch or another component generates keys and sends them to computing entities for use in generating capabilities, such as in response to requests from the computing entities.

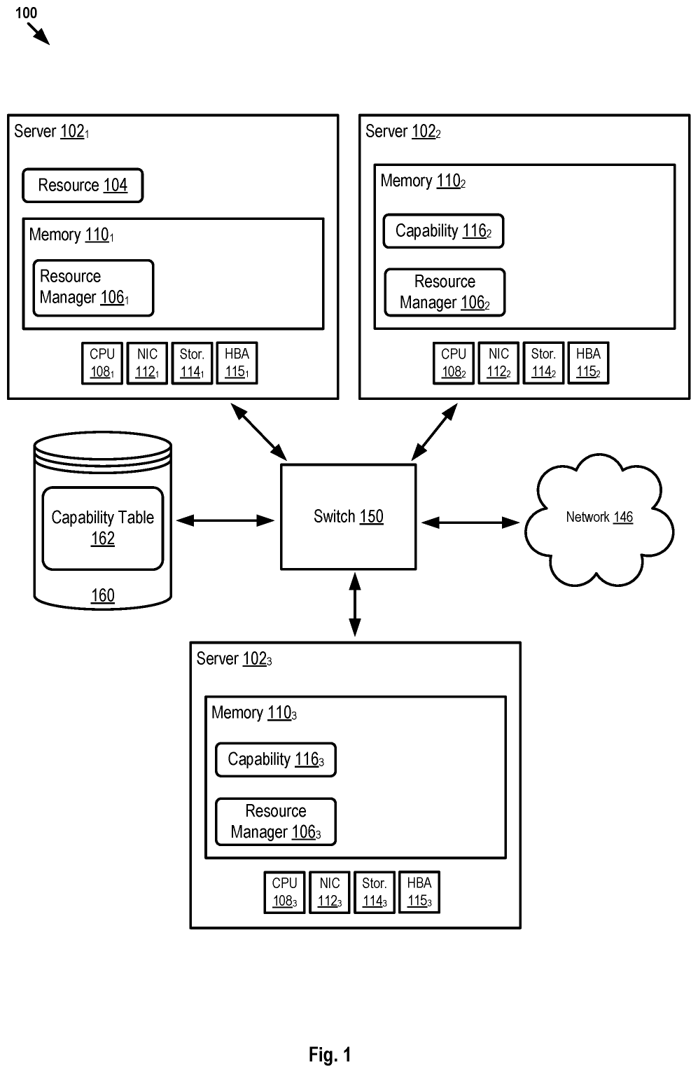

FIG. 1 illustrates a computing environment 100 within which embodiments of the present disclosure may be implemented.

Computing environment 100 includes a plurality of servers 102 connected by switch 150 to network 146. For example, the servers 102 may all be physical servers on a same rack and coupled to the same switch (e.g., physical switch). The switch may be further coupled to a network. Network 146 may be, for example, a direct link, a local area network (LAN), a wide area network (WAN) such as the Internet, another type of network, or a combination of these. Although FIG. 1 shows three servers 102, any number of servers 102, two or more, is possible within computing environment 100. Servers 102 may be physical computing entities such as rack servers, and computing environment 100 may, for example, be a rack-scale system or a data center. In alternative embodiments, servers 102 represent virtual computing instances, such as virtual machines, and the hardware components (memory, CPU, NIC, storage, host bus adapter or HBA, etc.) of each server 102 are virtualized components, such as virtualized through a hypervisor running on a physical host. If servers 102 are virtual machines, then each server may be on the same host or on different hosts. Each server 102 may be within the same data center, or may be located within a plurality of data centers.

Each server 102 comprises hardware components including central processing unit (CPU) 108, memory 110, and network interface controller (NIC) 112. A server may optionally also comprise other hardware or virtualized hardware components, such as storage 114 and host bus adapter (HBA) 115.

Each server 102 comprises resources, such as resource 104 shown on server 102₁. Resource 104 is shown only on server 102 for brevity, but each server 102 may have one or more resources, such as resource 104. Resource 104 may be any shareable resource present on server 102₁, such as some or all of memory 110₁, a file within memory 110₁, a network socket, some or all disk blocks of storage 114₁, space of a field-programmable gate array (FPGA), an interrupt vector, or the like. In some embodiments, resource 104 is divisible, meaning that resource 104 may be divided into two or more parts, such that each part can be individually shared with other servers 102. For example, resource 104 may be a region of memory 110₁, while a smaller portion of the region of memory 110₁ may be a shareable, accessible sub-part resulting from dividing of resource 104. Resource 104 may be associated with a set of rights. For example, resource 104 may be a region of memory 110₁ and associated with rights such as reading from and writing to resource 104. Each resource in computing environment 100 may have an owner, such as for example, server 102₁ or resource manager 106₁ may be the owner of resource 104 because resource 104 is located on server 102₁.

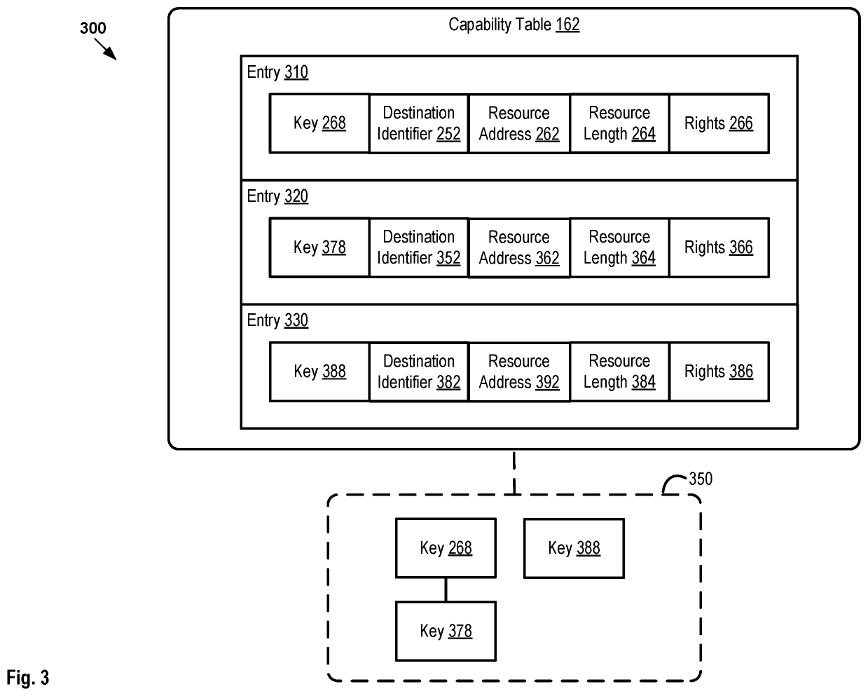

Switch 150 generally comprises a programmable switch that is used to implement resource control. Switch 150 is included as one potential embodiments, and techniques described herein as being implemented in switch 150 may alternatively be implemented in a different type of physical or logical entity, such as an application-specific integrated circuit (ASIC), a capability enforcement appliance, or the like. In some embodiments, switch 150 is a physical switch, while in other embodiments switch 150 is a virtual switch. Switch 150 is associated with a data store 160, which generally represents a data storage entity such as a database or repository. Data store 160 comprises capability table 162, in which switch 150 registers capabilities for servers 102 as described herein. Capability table 162 may also have associated metadata indicating hierarchical relationships among capabilities, such as a tree structure that indicates whether certain capabilities are derived from other capabilities. Capability table 162 and associated metadata are described in more detail below with respect to FIG. 3.

Resource 104 may be shareable by the owning server 102 with a second server 102 by providing to the second server a capability 116 associated with resource 104. The owning server 102 provides a capability 116 to a second server 102 via a grant message that is received by switch 150, which registers the capability 116 in capability table 162 and forwards the capability 116 to the second server 102. Each capability 116 generally includes a resource identifier, an indication of one or more rights, and a key generated by the provider of the capability 116. The key, when included in a request from the second server 102 to perform an operation associated with the capability 116 (e.g., a read or write message), allows the holder of the key to exercise rights associated with the key, the exercise of those rights being on the resource or the portion of the resource associated with the key. For example, a capability may give the holder the right to perform read or write operations with respect to memory 110, a file within memory 110, or to use a network socket associated with NIC 112. In another example, a capability may give the holder the right to read or write with respect to disk blocks of storage 114 or space of an FPGA.

In one example, resource 104 is a portion of memory 110₁, and capability 116₂ to resource 104 comprises a base address and a length, indicating the portion of memory 110₁ that is represented by resource 104. Capability 116₂ further comprises a set of rights, such as read-only, write-only, or both read and write, as well as a key. A capability to read and write to a portion of memory 110₁ may be a string, such as “[base address, length, r, w, key]”. Capability 116₂ to resource 104 is granted by server 102₁ to server 102₂, and is registered by switch 150 in capability table 162. To illustrate, if the set of rights is both read and write, then when server 102₂ issues a request to invoke capability 116₂, switch 150 allows server 102₂ to read from and write to the portion of memory 110₁ represented by resource 104 (e.g., by forwarding the request to server 102₁) based on an entry in capability table 162.

Capability 116 may be encrypted in some embodiments for security purposes, such as by the owner of the resource to which the capability 116 applies. When a capability 116 is transmitted from one server 102 to another server 102 via switch 150, the capability 116 may be transmitted using one or more secure channels that include point-to-point encryption techniques, such as those of Internet Protocol Security (IPSec), and an encryption key may be shared only between switch 150 and the servers 102 involved in the capability exchange.

Resource manager 106 is a component executing within each server 102. Resource manager 106 manages resources (e.g., resource 104), division of resources, access to resources, and generation of capabilities to resources, for resources located on the same server 102 as the server 102 on which resource manager 106 is located. Resource manager 106 may be a component within an operating system of server 102.

For example, to grant capability 116₂ associated with resource 104 to another server 102₂, resource manager 106₁ generates capability 116₂, including generating a unique key for capability 116₂, and transmits capability 116₂ to switch 150 via a grant message. Switch 150 parses the grant message, registers capability 116₂ in capability table 162, and forwards the grant message to server 102₂. Components, such as applications, on server 102₂ may then use the granted capability 116₂ to access resource 104. When a component on server 102₂ would like to access resource 104, server 102₂ may send an invoke (or read, write, revoke, or the like) message to switch 150, the message comprising capability 116₂, including the key. Switch 150 parses the message, verifies that capability 116₂ is registered in capability table 162 (including verifying the key and ensuring that the server 102₂ has the requisite rights to perform the operation(s) requested in the message) and, upon successful verification, forwards the message to server 102₁. In some embodiments, switch 150 drops the message if it cannot successfully verify that server 102₂ has been granted the capability 116₂. When owner server 102₁ receives the message, server 102₁ (e.g., via resource manager 106₁) allows the requested operation to the resource by executing the operation (e.g., reading or writing with respect to resource 104).

Once capability 116₂ has been granted to server 102₂, server 102₂ may grant all or a subset of the rights included in capability 116₂ (e.g., as a new capability 116₃ generated by resource manager 1062) to another server 102₃ via a mint message that is parsed and registered in capability table 162 by switch 150 and forwarded to server 102₃. Switch 150 may verify that server 102₂ has capability 116₂ before registering capability 116₃, thereby ensuring that server 102₂ has the rights to grant capability 116₃ with respect to resource 104 of server 102₁. In some embodiments, switch 150 also stores metadata in association with capability table 162, such as a tree structure indicating that capability 116₂ is a parent of capability 116₃. In one example, the tree structure comprises the keys associated with the capabilities organized in a hierarchical data structure. Subsequently, server 102₃ will be able to perform at least a subset of the operations allowed by capability 116₂ with respect to resource 104 using capability 116₃. For example, server 102₂ may want to grant an attenuated, limited, or restricted version of capability 116₂ to server 102₃. An “attenuated,” “limited,” or “restricted” capability of another capability is (a) a capability to a subpart of the other capability (e.g., a subrange of memory or disk space or the like), and/or (b) a capability with rights that are more restricted than the rights of the other capability. For example, server 102₂ may want to grant capability 116₃ to a sub-part of resource 104, may want to grant capability 116₃ with more restricted rights to resource 104 as compared to capability 116₂, or both. Alternatively, server 102₂ may grant all of the rights in capability 116₂ to server 102₃ via capability 116₃.

In one example, server 102₁ revokes capability 116₂ from server 102₂ via a revoke message. Switch 150 parses the revoke message and removes the entry corresponding to capability 116₂ from capability table 162. In certain embodiments, switch 150 also determines that capability 116₂ is a parent of capability 116₃, such as based on metadata associated with capability table 162, which may include a tree structure. Because capability 116₃ is a child of capability 116₂, switch 150 also removes the entry corresponding to capability 116₃ based on the revoke command.

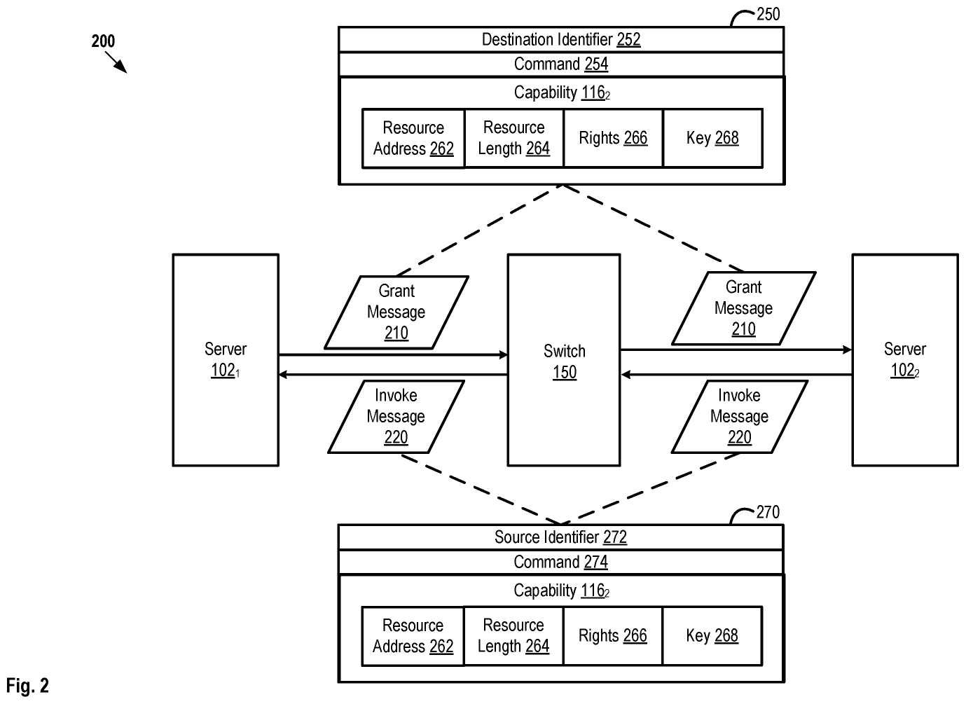

FIG. 2 illustrates an example 200 of resource control according to embodiments of the present disclosure. Example 200 includes servers 102₁ and 102₂, switch 150, and capability 116₂ of FIG. 1. FIG. 2 is described in conjunction with FIG. 3, which illustrates an example 300 of a capability table according to embodiments of the present disclosure

In example 200, switch 150 receives grant message 210 from server 102₁. In some embodiments, server 102₁ sends grant message 210 directly to server 102₂ and switch 150 intercepts grant message 210, while in other embodiments, server 102₁ sends grant message 210 directly to switch 150. In certain embodiments, switch 150 receives grant message 210 via a normal data path by which all packets are routed through computing environment 100 of FIG. 1, and resource control is performed as part of the switching logic of the computing environment. Grant message 210 may be sent by server 102₁ in response to a request from server 102₂, or may be sent independently of any request.

In some embodiments, capability directive 250 represents a header of grant message 210, which may implemented on top of another protocol, such as Ethernet, internet protocol (IP), transmission control protocol (TCP), user datagram protocol (UDP), or the like. For example, the header may be an option header of a generic network virtualization encapsulation (GENEVE) header, a Q-in-Q header, or the like. In alternative embodiments, some or all of the information depicted in capability directive 250 may be included in a payload of a packet rather than in a header. As shown in capability directive 250, grant message 210 includes destination identifier 252, which is a bit pattern indicating the computing entity to which grant message 210 is directed. In this case, destination identifier 252 is an internet protocol (IP) address of server 102₂. In other embodiments (not shown) grant message 210 also includes a source identifier, such as an IP address of server 102₁. In alternative embodiments, the header of grant message 210 does not include either a destination identifier or source identifier, such as if this information is already included in an underlying format of the packet used to implement grant message 210.

Grant message 210 also includes command 254, which indicates a command related to resource control. In this case, command 254 indicates a grant command.

Grant message 210 also includes capability 116₂. In alternative embodiments, grant message 210 includes a plurality of capabilities. Capability 116₂ comprises resource address 262, which is the base address of the memory region or identifier of the object that capability 116₂ corresponds to. Resource address 262 may also include a bit pattern that logically encodes the source address (e.g., an address of server 102₁) of the computing entity on which the resource is located.

Capability 116₂ also includes resource length 264, which indicates a length of the memory region or object to which capability 116₂ corresponds.

Capability 116₂ also includes rights 266, which indicate the rights that are granted by grant message 210. In this case, rights 266 indicate that rights to perform read and write operations are granted.

Capability 116₂ also includes key 268, which is a random bit pattern generated by server 102₁ that is used to verify validity of capability 116₂, and is kept secret between servers 102₁ and 102₂ and switch 150.

Switch 150 parses grant message 210 and registers capability 116₂ in capability table 162 of FIG. 1. As shown in example 300 of FIG. 3, switch 150 generates an entry 310 in capability table 162 based on grant message 210. Entry 310 includes key 268, which is used as an index for entry 310 in capability table 162, as well as destination identifier 252, resource address 262, resource length 264, and rights 266. In certain embodiments, switch 150 registers capability 116₂ in capability table 162 by notifying a control plane of switch 150, which then adds entry 310 to capability table 162.

After registering capability 116₂ in capability table 162, switch 150 forwards grant message 210 to server 102₂.

Server 102₂ then sends an invoke message 220 to switch 150 (and/or directly to server 102₁) in order to perform an operation that falls within the scope of capability 116₂. As shown in capability directive 270, which may represent a header of invoke message 220, invoke message 220 includes source identifier 272 (e.g., an address of server 102₂), command 274 (e.g., read, write, and/or the like), and capability 116₂. In some embodiments, invoke message 220 also includes a destination identifier, such as an address of server 102₁.

Switch 150 parses invoke message 220 and verifies that server 102₂ has the requisite rights. In certain embodiments, switch 150 verifies that capability 116₂ has been registered in capability table 162 (e.g., by confirming the existence of entry 310), and, if so, verifies that the capability information, including the key 268, included in invoke message 220 matches the capability information in entry 310 of capability table 162. Source identifier 272 may be compared to destination identifier 252 in entry 310 to verify that the invoke message is received from an entity that was granted the capability. Upon successful verification, switch 150 forwards invoke message 220 to server 102₁, which performs the operation(s) indicated in command 274. Upon unsuccessful verification (which is not the case in example 200), switch 150 drops invoke message 220.

While example 200 shows invoke message 220 having the same content both before and after it is processed by switch 150, other embodiments involve switch 150 translating invoke message 220 into another format before forwarding it to server 102₁. For example, switch 150 may translate invoke message 220 into a remote direct memory access (RDMA) read/write request before forwarding.

In example 300, capability table 162 also includes entry 320, which is registered in capability table 162 by switch 150 in response to a mint message issued by server 102₂ to grant a subset of capability 116₂ to server 102₃. Entry 320 includes key 378 (e.g., a unique key different than key 268), destination identifier 352 (e.g., an address of server 102₃), resource address 362 (e.g., a base address of a memory region that is at least a subset of the memory region corresponding to capability 116₂), resource length 364 (e.g., the length of the memory region), and rights 366 (e.g., an indication of at least a subset of rights 266). Capability table 162 also includes entry 330, which is registered in capability table 162 by switch 150 in response to another grant message from server 102₁. Entry 330 includes key 388 (e.g., a unique key different than key 268 and key 378), destination identifier 382 (e.g., an address of server 102₂ or 102₃), resource address 392 (e.g., a base address of a region of an FPGA of server 102₁), resource length 384 (e.g., a length of the region of the FPGA), and rights 386 (e.g., indicating read and/or write).

Metadata 350 is associated with capability table 162, and comprises a tree structure that indicates hierarchical relationships among the keys of capabilities registered in capability table 162. In metadata 350, key 268 is a parent of key 378, as key 378 corresponds to a capability that was minted based on the capability corresponding to key 268. Key 388 does not have a parent because it was not generated based on another capability.

If server 102₁ issues a revoke message to revoke capability 116₂ from server 102₂, then switch 150 removes entry 310 from capability table 162. Switch 150 also determines which entries are descendants of entry 310 based on metadata 350, identifying entry 320 as a descendant of entry 310 (as key 378 is a child of key 268 in metadata 350). As such, switch 150 also removes entry 320 from capability table 162. In alternative embodiments, rather than removing entries 310 and 320, switch 150 modifies rights 266 and 366 to remove all rights listed. In some embodiments, revoke functionality is implemented as part of a control plane of switch 150. A simple implementation is a recursive walk through the table starting with the parent key as the current key to scan for. Whenever a parent of a given key in metadata 350 matches the current key, the table entry corresponding to the given key is deleted or invalidated and the given key is pushed on a queue. This process is repeated until the table and metadata have been scanned and no more children have been found. Care must be taken to avoid a case where new capabilities are minted while revoke is in process. As such, in certain embodiments, a two-step approach is used (similar to two phase commit) where capabilities are first marked for revoke and then finally deleted. Finally, the computing entity that sent the revoke message should be notified when the revoke command is complete.

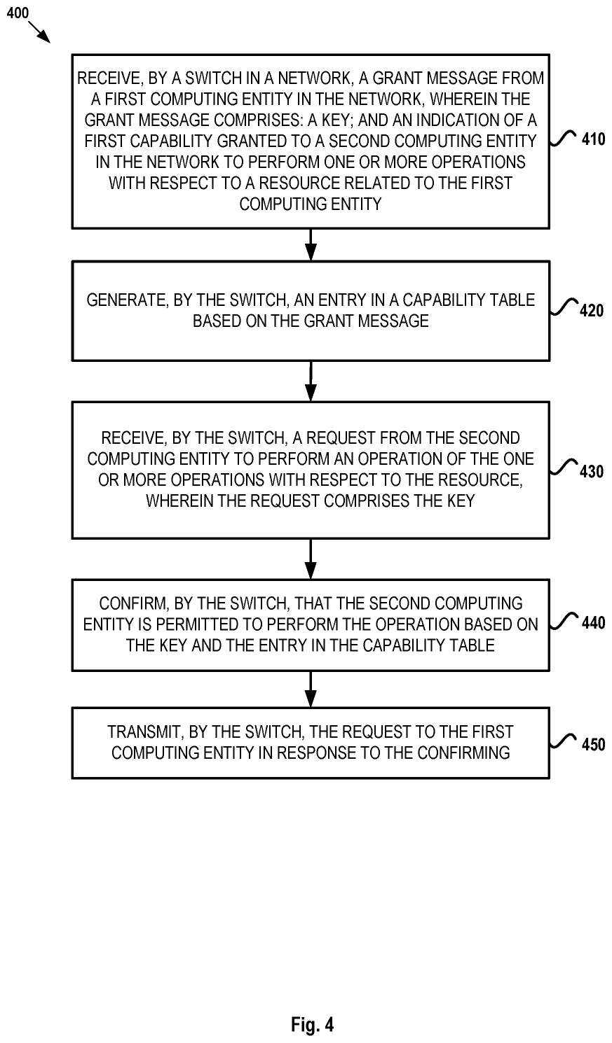

FIG. 4 illustrates example operations 400 for resource control according to embodiments of the present disclosure. In some embodiments, operations 400 are performed by switch 150 of FIG. 1.

Operations 400 begin at step 410, where a switch in a network receives a grant message from a first computing entity in the network, wherein the grant message comprises a key and an indication of a first capability granted to a second computing entity in the network to perform one or more operations with respect to a resource related to the first computing entity.

In some embodiments, the grant message comprises an identifier of a memory region corresponding to the resource, a length of the memory region, the indication of the first capability, and the key. In some embodiments, the grant message further comprises a bit pattern indicating that the second computing entity is a recipient of the grant message. For example, as shown in FIG. 2, switch 150 receives grant message 210 from server 102₁. In certain embodiments, the one or more operations comprise one or more of: read, write, or invoke. In some embodiments, the resource is a memory region, a storage region, a portion of an FPGA, a network port, or an application on the first computing device.

At step 420, the switch generates an entry in a capability table based on the grant message. For example, as shown in FIG. 3, entry 310 is generated in capability table 162.

At step 430, the switch receives a request from the second computing entity to perform an operation of the one or more operations with respect to the resource, wherein the request comprises a key. For example, as shown in FIG. 2, switch 150 receives invoke message 220 (e.g., the request) from server 102₂.

At step 440, the switch confirms that the second computing entity is permitted to perform the operation based on the key and the entry in the capability table. In an embodiment, switch 150 of FIG. 1 confirms that entry 310 of FIG. 3 is present in capability table 265 of FIG. 3 and then compares the key in the request to key 268 in entry 310 of FIG. 3.

At step 450, the switch transmits the request to the first computing entity in response to the confirming. In an example, as shown in FIG. 2, switch 150 transmits invoke message 220 to server 102₁ after the confirming. In an alternative embodiment, the switch is unable to confirm that the second computing entity is permitted to perform the operation, and drops the request without transmitting it to the first computing entity. In some embodiments, the switch translates the request into a format associated with the operation of the one or more operations, such as an RDMA request, before transmitting it to the first computing entity. The first computing entity, upon receiving the request, may perform the operation. In some embodiments, the results of the operation (e.g., the data obtained by a read operation) are received by switch 150 from server 102₁ and transmitted by switch 150 back to server 102₂.

Certain embodiments further include receiving, by the switch, a revocation message from the first computing entity indicating that the first capability is revoked for the second computing entity and removing the entry from the capability table based on the revocation message. Some embodiments include determining, by the switch, that an additional entry in the capability table is a descendant of the entry and removing the additional entry from the capability table based on the revocation message.

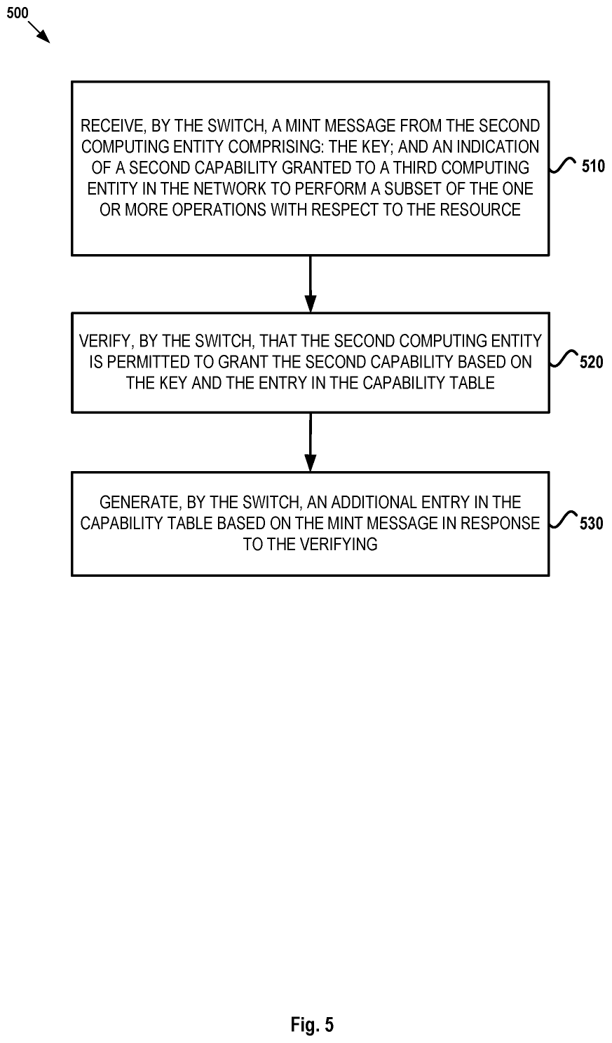

FIG. 5 illustrates additional example operations 500 for resource control according to embodiments of the present disclosure. For example, operations 500 may be performed by switch 150 of FIG. 1 after operations 400 of FIG. 4 have been performed.

Operations 500 begin at step 510, where the switch receives a mint message from the second computing entity comprising: the key; and an indication of a second capability granted to a third computing entity in the network to perform a subset of the one or more operations with respect to the resource. For example, with respect to FIG. 1, switch 150 may receive a mint message from server 102₂, which grants a subset of the rights in capability 116₂ to server 102₃.

At step 520, the switch verifies that the second computing entity is permitted to grant the second capability based on the key and the entry in the capability table. For example, switch 150 of FIG. 1 may confirm that entry 310 of FIG. 3 is present in capability table 265 of FIG. 3, and may compare a key included in the mint request (e.g., the key of capability 116₂) to key 268 of FIG. 3. In some embodiments, the mint message includes both the key of the first capability and a new key of the second capability.

At step 520, the switch generates an additional entry in the capability table based on the mint message in response to the verifying. For example, entry 320 of FIG. 3 may be generated in capability table 265 of FIG. 3 based on the verifying. In some embodiments, metadata associated with the capability table is generated to indicate that the first capability is a parent of the second capability, such as via a tree structure in which the key of the first capability is a parent of the key of the second capability.

Certain embodiments as described above involve a hardware abstraction layer on top of a host computer. The hardware abstraction layer allows multiple contexts or virtual computing instances to share the hardware resource. In one embodiment, these virtual computing instances are isolated from each other, each having at least a user application running therein. The hardware abstraction layer thus provides benefits of resource isolation and allocation among the virtual computing instances. In the foregoing embodiments, virtual machines are used as an example for the virtual computing instances and hypervisors as an example for the hardware abstraction layer. As described above, each virtual machine includes a guest operating system in which at least one application runs. It should be noted that these embodiments may also apply to other examples of virtual computing instances, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)-CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for resource protection in a network, comprising:
receiving, by a switch in the network, a grant message from a first computing entity in the network, wherein the grant message comprises:
a key; and
an indication of a first capability granted to a second computing entity in the network to perform one or more operations with respect to a resource related to the first computing entity;
generating, by the switch, an entry in a capability table based on the grant message;
receiving, by the switch, a request from the second computing entity to perform an operation of the one or more operations with respect to the resource, wherein the request comprises the key;
confirming, by the switch, that the second computing entity is permitted to perform the operation based on the key and the entry in the capability table; and
transmitting, by the switch, the request to the first computing entity in response to the confirming.

2. The method of claim 1, further comprising:
receiving, by the switch, a mint message from the second computing entity comprising:
the key; and
an indication of a second capability granted to a third computing entity in the network to perform a subset of the one or more operations with respect to the resource;
verifying, by the switch, that the second computing entity is permitted to grant the second capability based on the key and the entry in the capability table; and
generating, by the switch, an additional entry in the capability table based on the mint message in response to the verifying.

3. The method of claim 1, further comprising:
receiving, by the switch, a revocation message from the first computing entity indicating that the first capability is revoked for the second computing entity; and
removing the entry from the capability table based on the revocation message.

4. The method of claim 3, further comprising:
determining that an additional entry in the capability table is a descendant of the entry; and
removing the additional entry from the capability table based on the revocation message.

5. The method of claim 1, wherein:
the grant message comprises:
an identifier of a memory region corresponding to the resource;
a length of the memory region;
the indication of the first capability; and
the key; and
the one or more operations comprise one of:
read;
write; or
invoke.

6. The method of claim 1, further comprising:
receiving, by the switch, results of the operation from the first computing entity; and
transmitting, by the switch, the results of the operation to the second computing entity.

7. The method of claim 1, wherein transmitting, by the switch, the request to the first computing entity in response to the confirming comprises translating the request into a format associated with the operation of the one or more operations.

8. A computer system comprising: one or more processors; and a non-transitory computer-readable medium storing instructions that, when executed, cause the computer system to perform a method for resource protection in a network, the method comprising:
receiving, by a switch in the network, a grant message from a first computing entity in the network, wherein the grant message comprises:
a key; and
an indication of a first capability granted to a second computing entity in the network to perform one or more operations with respect to a resource related to the first computing entity;
generating, by the switch, an entry in a capability table based on the grant message;
receiving, by the switch, a request from the second computing entity to perform an operation of the one or more operations with respect to the resource, wherein the request comprises the key;
confirming, by the switch, that the second computing entity is permitted to perform the operation based on the key and the entry in the capability table; and
transmitting, by the switch, the request to the first computing entity in response to the confirming.

9. The computer system of claim 8, wherein the method further comprises:
receiving, by the switch, a mint message from the second computing entity comprising:
the key; and
an indication of a second capability granted to a third computing entity in the network to perform a subset of the one or more operations with respect to the resource;
verifying, by the switch, that the second computing entity is permitted to grant the second capability based on the key and the entry in the capability table; and
generating, by the switch, an additional entry in the capability table based on the mint message in response to the verifying.

10. The computer system of claim 8, wherein the method further comprises:
receiving, by the switch, a revocation message from the first computing entity indicating that the first capability is revoked for the second computing entity; and
removing the entry from the capability table based on the revocation message.

11. The computer system of claim 10, wherein the method further comprises:
determining that an additional entry in the capability table is a descendant of the entry; and
removing the additional entry from the capability table based on the revocation message.

12. The computer system of claim 8, wherein:
the grant message comprises:
an identifier of a memory region corresponding to the resource;
a length of the memory region;
the indication of the first capability; and
the key; and
the one or more operations comprise one of:
read;
write; or
invoke.

13. The computer system of claim 8, wherein the method further comprises:
receiving, by the switch, results of the operation from the first computing entity; and
transmitting, by the switch, the results of the operation to the second computing entity.

14. The computer system of claim 8, wherein transmitting, by the switch, the request to the first computing entity in response to the confirming comprises translating the request into a format associated with the operation of the one or more operations.

15. A non-transitory computer readable medium comprising instructions that, when executed by one or more processors of a computing system, cause the computing system to perform a method for resource protection in a network, the method comprising:
receiving, by a switch in the network, a grant message from a first computing entity in the network, wherein the grant message comprises:
a key; and
an indication of a first capability granted to a second computing entity in the network to perform one or more operations with respect to a resource related to the first computing entity;
generating, by the switch, an entry in a capability table based on the grant message;
receiving, by the switch, a request from the second computing entity to perform an operation of the one or more operations with respect to the resource, wherein the request comprises the key;
confirming, by the switch, that the second computing entity is permitted to perform the operation based on the key and the entry in the capability table; and
transmitting, by the switch, the request to the first computing entity in response to the confirming.

16. The non-transitory computer readable medium of claim 15, wherein the method further comprises:
receiving, by the switch, a mint message from the second computing entity comprising:
the key; and
an indication of a second capability granted to a third computing entity in the network to perform a subset of the one or more operations with respect to the resource;
verifying, by the switch, that the second computing entity is permitted to grant the second capability based on the key and the entry in the capability table; and
generating, by the switch, an additional entry in the capability table based on the mint message in response to the verifying.

17. The non-transitory computer readable medium of claim 15, wherein the method further comprises:
receiving, by the switch, a revocation message from the first computing entity indicating that the first capability is revoked for the second computing entity; and
removing the entry from the capability table based on the revocation message.

18. The non-transitory computer readable medium of claim 17, wherein the method further comprises:
determining that an additional entry in the capability table is a descendant of the entry; and
removing the additional entry from the capability table based on the revocation message.

19. The non-transitory computer readable medium of claim 15, wherein:
the grant message comprises:
an identifier of a memory region corresponding to the resource;
a length of the memory region;
the indication of the first capability; and
the key; and
the one or more operations comprise one of:
read;
write; or
invoke.

20. The non-transitory computer readable medium of claim 15, wherein the method further comprises:
receiving, by the switch, results of the operation from the first computing entity; and
transmitting, by the switch, the results of the operation to the second computing entity.
